(19) United States
(12) Patent Application Publication
(10) Pub. No.: US 2017/0085016 A1
(43) Pub. Date: Mar. 23, 2017

(54) PRESS-FIT TERMINAL

(71) Applicant: AISIN SEIKI KABUSHIKI KAISHA, Kariya-shi (JP)

(72) Inventors: Hiroaki SASAYAMA, Nagoya-shi (JP); Yosuke TAKATA, Nagoya-shi (JP)

(73) Assignee: AISIN SEIKI KABUSHIKI KAISHA, Kariya-shi (JP)

(21) Appl. No.: 15/257,283

(22) Filed: Sep. 6, 2016

(30) Foreign Application Priority Data
Sep. 18, 2015 (JP) 2015-184606
May 23, 2016 (JP) 2016-102090

(51) Int. Cl. H01R 12/58; H01R 13/03

(52) U.S. Cl. CPC H01R 12/585; H01R 13/03

(57) ABSTRACT

A press-fit terminal includes: a base material; and a plated surface layer which is obtained by plating a surface of the base material with an Sn—Ni alloy.

### CROSS REFERENCE TO RELATED APPLICATIONS

This application is based on and claims priority under 35 U.S.C. §119 to Japanese Patent Application 2015-184606, filed on Sep. 18, 2015 and Japanese Patent Application 2016-102090, filed on May 23, 2016, the entire contents of which are incorporated herein by reference.

### TECHNICAL FIELD

This disclosure relates to a press-fit terminal.

### BACKGROUND DISCUSSION

An electronic control device uses a press-fit terminal as a connecting terminal which connects to an electronic circuit, a power circuit, or the like. The press-fit terminal is a connecting terminal which is electrically connected to an inner surface of a through hole on an electronic circuit board, and is press-fitted into the through hole. There is a concern that when the press-fit terminal is press-fitted into the through hole, a terminal surface is scraped, and thus the surface of the terminal is subjected to a plating treatment.

For example, the following surface treatment is performed in JP 2006-114492A Reference 1).

First, a surface of a base material is subjected to Ni (nickel) plating so as to form a plated base layer. Next, the surface of the plated base layer is sequentially subjected to Cu (copper) plating and Sn (tin) plating. Further, a reflow treatment (a heat treatment) is performed on the base material which is subjected to the above-described plating.

With such a treatment, a Cu—Sn alloy layer having surface hardness which is higher than that of an Sn layer is formed on the surface of the press-fit terminal (the base material).

However, a melting point of Cu is higher than a melting point of Sn, and thus it is difficult to sufficiently melt a Cu-plated layer during the reflow treatment, and Cu is not uniformly dispersed in an Sn-plated layer, or Cu cannot be deposited on the surface of the Sn-plated layer, which is a problem easily occurring in a surface treatment method disclosed in Reference 1. In addition, there is a concern that the Cu—Sn alloy layer is not uniformly formed on the surface layer of the base material due to the film thickness variation between the Cu-plated layer (coated film) and the Sn-plated layer (coated film) in the process of the surface treatment.

Due to the above-described factors, in the surface treatment method, there was a problem in that the surface hardness of the plated surface layer of the press-fit terminal is partially decreased, and the plated layer is locally scrapped when the press-fit terminal is press-fitted into the through hole. For this reason, the corresponding technical field has required a press-fit terminal of which a surface is less likely to be scrapped as compared with that in the related art.

### SUMMARY

Thus, a need exists for a press-fit terminal which is not suspectable to the drawback mentioned above.

It is preferable that a press-fit terminal according to an aspect of this disclosure includes a base material and a plated surface layer which is obtained by plating a surface of the base material with an Sn—Ni alloy.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a diagram illustrating a state where a press-fit terminal according to an embodiment of this disclosure is press-fitted into a through hole on an electronic circuit board;

FIG. 2 is a sectional view of a press-fitting portion of the press-fit terminal;

FIG. 3 is a table indicating plating conditions and respective test results of the press-fit terminals in Examples 1 and 2, and Comparative examples 1 and 2; and

FIG. 4 is a table indicating plating conditions and respective test results of the press-fit terminals in Example 3 belonging to a second embodiment, Example 4 belonging to a third embodiment, and Example 5 belonging to a fourth embodiment of this disclosure.

### DETAILED DESCRIPTION

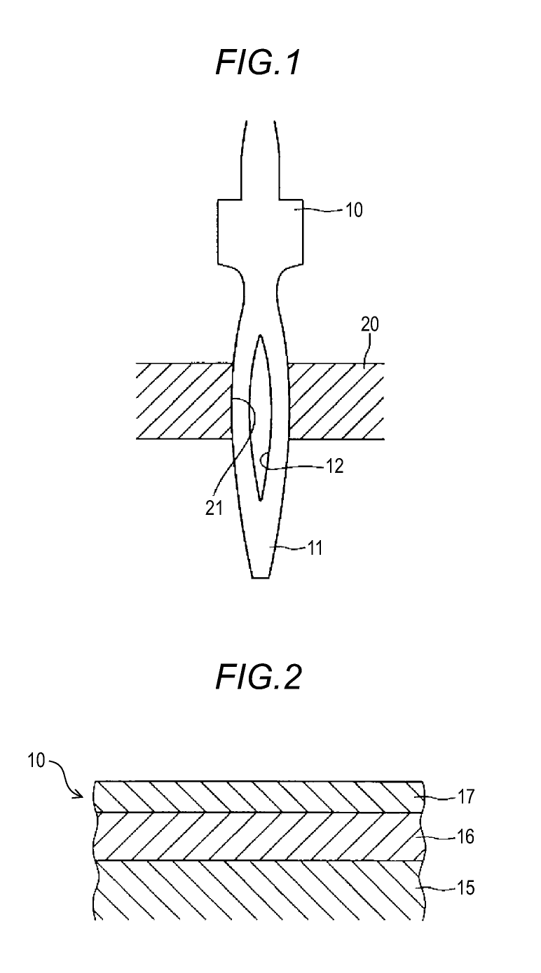

Hereinafter, the first embodiment of this disclosure will be described with reference to FIG. 1 to FIG. 3.

A press-fit terminal 10 is formed into an elongated shape. As illustrated in FIG. 1, the press-fit terminal 10 is provided with a press-fitting portion 11 on the tip end side. A slit 12 is formed in the press-fitting portion 11, and thus the press-fitting portion 11 is elastically deformable in the width direction of the press-fit terminal 10.

An electronic circuit (not shown) is formed on the surface of an electronic circuit board 20 as illustrated in FIG. 1, and a surface of a through hole 21 is subjected to metal plating so as to be connected to the electronic circuit.

When the press-fitting portion 11 of the press-fit terminal 10 is press-fitted into the through hole 21 of the electronic circuit board 20, the press-fitting portion 11 is in contact with the surface of the through hole 21 while being elastically deformed in a direction in which the width becomes smaller. For this reason, the press-fit terminal 10 and the electronic circuit of the electronic circuit board 20 are electrically conducted with each other via the metal plating of the through hole 21.

The press-fit terminal 10 is manufactured by performing a plating treatment on the surface of the base material which is obtained through a pressing process of a substrate. The aforementioned substrate (the base material) is made of Cu or a Cu alloy. Through the pressing process, the press-fit terminal 10 is formed from the substrate into the shape as illustrated in FIG. 1. Further, a plated base layer 16 which is an Ni-coated film is formed on a surface (including the sectional view formed at the time of the pressing process) of a base material 15 as illustrated in FIG. 2. The thickness of the plated base layer 16 is in a range of 0.5 to 2.0 μm. The plated base layer 16 is formed on the surface of the base material 15 through electroplating by using a plating solution containing, for example, Ni ions. Note that, it is preferable that a surface treatment (such as electrolytic degreasing, acid washing, and water washing) is performed on the surface of the base material 15 before forming the plated base layer 16 on the surface of the base material 15.

Further, as illustrated in FIG. 2, a plated surface layer (coated film) 17 which is made of an Sn—Ni alloy is formed on the surface of the plated base layer 16.

The plated surface layer 17 is formed on the surface of the press-fit terminal 10 through the electroplating by using an Sn—Ni alloy plating solution containing, for example, Sn ions and Ni ions. In consideration of plating conditions such as the ratio of the Sn ions to Ni ions in the Sn—Ni alloy plating solution and a chelating agent, Ni is uniformly dispersed into the plated surface layer 17 and is deposited on the surface of the plated surface layer 17. In this case, the reflow treatment is not necessarily performed after the plating treatment of the plated surface layer 17 is performed on the surface of the plated base layer 16. Note that, it is preferable that a surface treatment (such as acid washing and water washing) is performed on the surface of the plated base layer 16 before the plating treatment is performed on the plated surface layer 17.

The content of Ni in the plated surface layer 17 is set to be in a range of 10 wt % to 40 wt %. In addition, the thickness of the plated surface layer 17 is in a range of 0.5 to 2.0 μm.

Ni is uniformly dispersed into the plated surface layer 17 and is deposited on the surface of the plated surface layer 17, and thus the entire surface hardness of the plated surface layer 17 is sufficiently high. For this reason, when the press-fitting portion 11 of the press-fit terminal 10 is press-fitted into the through hole 21 of the electronic circuit board 20, the plated surface layer 17 which is the surface of the press-fitting portion 11 is less likely to be scrapped by the surface of the through hole 21.

Accordingly, it is possible to reliably connect the press-fit terminal 10 and the electronic circuit board 20 to each other.

Note that, in a case where the content of Ni in the plated surface layer 17 is less than 10 wt %, the degree of the entire surface hardness of the plated surface layer 17 is not sufficient. Therefore, in this case, it is likely that the plated surface layer 17 of the press-fitting portion 11 is scrapped when the press-fitting portion 11 of the press-fit terminal 10 is press-fitted into the through hole 21 of the electronic circuit board 20.

In addition, in a case where the content of Ni in the plated surface layer 17 is more than 40 wt %, it is difficult to perform the Sn—Ni alloy plating on the press-fit terminal 10 so as to set a desired Ni ratio. Further, in this case, the contact resistance of the press-fitting portion 11 of the press-fit terminal 10 with respect to the through hole 21 of the electronic circuit board 20 becomes excessively larger.

However, when the content of Ni in the plated surface layer 17 is set to be in a range of 10 wt % to 40 wt % as described in the embodiment, it is possible to reduce the occurrence of the above-described defects.

In addition, in the press-fit terminal 10, the plated base layer 16 is interposed between the base material 15 and the plated surface layer 17.

Therefore, it is possible to prevent Cu in the base material 15 from being dispersed into the plated surface layer 17 (Sn) by the plated base layer 16.

Subsequently, an example (Example 1) of this disclosure will be described with a comparative example. Note that, the base materials of the press-fit terminals have substantially the same dimension in Example 1 and the respective comparative examples. Further, a material of each of the base materials is Cu.

### Example 1

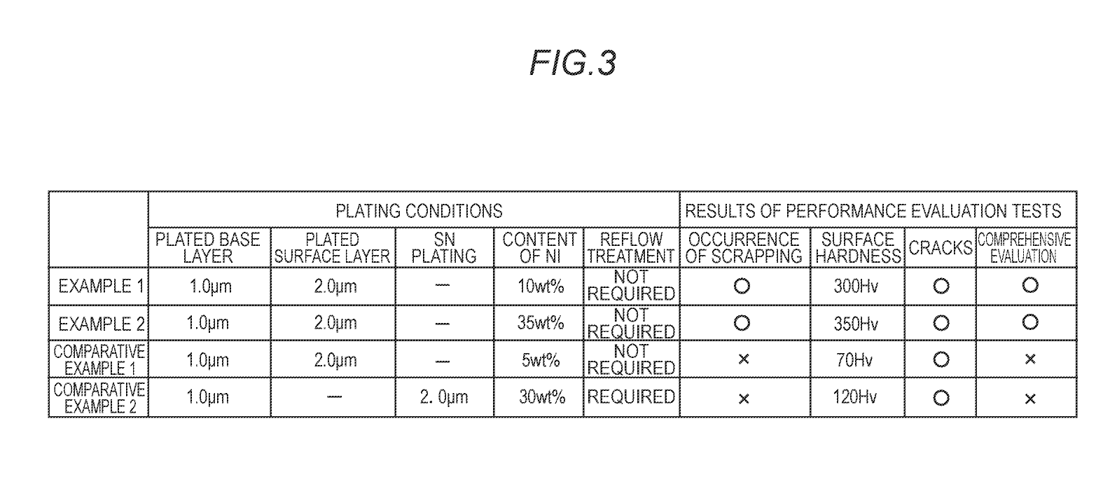

The press-fit terminal in Example 1 is manufactured by using the same manufacturing method as that of the press-fit terminal 10 in the above-described embodiment. As indicated in Table of FIG. 3, the thickness of the plated base layer of the press-fit terminal in Example 1 is 1.0 μm, and the thickness of the plated surface layer is 2.0 μm. Further, the content of Ni in the plated surface layer is 10 wt %.

### Example 2

The press-fit terminal in Example 2 is manufactured by using the same manufacturing method as that of the press-fit terminal 10 in the above-described embodiment. As indicated in Table of FIG. 3, the thickness of the plated base layer of the press-fit terminal in Example 2 is 1.0 μm, and the thickness of the plated surface layer is 2.0 μm. Further, the content of Ni in the plated surface layer is 35 wt %.

### Comparative Example 1

The press-fit terminal in Comparative example 1 is manufactured by using the same manufacturing method as that of the press-fit terminal 10 in the above-described embodiment. As indicated in Table of FIG. 3, the thickness of the plated base layer of the press-fit terminal in Comparative example 1 is 1.0 μm, and the thickness of the plated surface layer is 2.0 μm. Further, the content of Ni in the plated surface layer is 5 wt %.

### Comparative Example 2

The press-fit terminal in Comparative example 2 which is indicated in Table of FIG. 3 is manufactured by using a different manufacturing method from that of the press-fit terminal 10 in the above-described embodiment. That is, the Sn-plated layer is formed on the surface of the Ni-plated layer after the Ni-plated layer is formed on the surface of the base material, and then the reflow treatment is performed on the press-fit terminal, thereby manufacturing the press-fit terminal in Comparative example 2. The plated base layer 16 is formed through the electroplating by using the plating solution which contains Ni ions. In this case, the Sn-plated layer and the Ni-plated layer are melted during the reflow treatment, and thus an Sn—Ni alloy is formed at a boundary between the Sn-plated layer and the Ni-plated layer. However, since the plated surface layer is thickened, Ni is difficult to be diffused in the inside of the Sn-plated layer during the reflow treatment, and thus Ni does not appear on the outermost surface of the plated surface layer. Note that, a brightening agent is not added to the aforementioned plating solution.

The thickness of the Ni-plated layer (base plated layer) of the press-fit terminal in Comparative example 2 is 1.0 μm, and the thickness of the Sn-plated layer (plated surface layer) is 2.0 μm. In addition, the content of Ni in the Sn-plated layer (plated surface layer) is 30 wt %.

Subsequently, results of performance evaluation tests of Examples 1 and 2, and Comparative examples 1 and 2 will be described below.

### Scraping Suppression Test

Each of the press-fitting portions of the respective press-fit terminals in Examples 1 and 2, and Comparative examples 1 and 2 press-fits (is inserted) into the through hole 21 of the electronic circuit board 20, and then the amount of the scrapings generated in the plating was visually confirmed. Specifically, after each of the press-fit terminals is inserted into the through hole 21, the existence of the scrapings generated in the plating which are collected in the vicinity of the through hole 21 was visually evaluated with the press-fit terminals in a state of being inserted into the through hole 21. As a result, it was not possible to confirm the scrapings in Examples 1 and 2 as indicated in Table of FIG. 3. On the other hand, the scrapings were confirmed in Comparative examples 1 and 2.

The content of Ni in the plated surface layer of the press-fit terminal in Comparative example 1 is 5 wt %, which is less than that in Examples 1 and 2. Therefore, the surface hardness of the plated surface layer is not sufficient, and thus, it is estimated that the amount of scrapping is larger than that in Examples 1 and 2.

In the press-fit terminal in Comparative example 2, the Sn-plated layer and the Ni-plated layer are melted by performing the reflow treatment such that an Sn—Ni alloy is formed at a boundary between the Sn-plated layer and the Ni-plated layer. However, the plated surface layer is thickened, and thus Ni is not uniformly diffused into the Sn-plated layer during the reflow treatment. That is, Ni does not appear or almost does not appear on the outermost plated surface layer. In this case, the surface hardness of the plated surface layer becomes decreased, and thus it is estimated that the plated surface layer is scrapped by the through hole 21.

### Surface Hardness Test

The surface hardness of the press-fit terminals in Examples 1 and 2, and Comparative examples 1 and 2 was measured through a Vickers hardness test. Meanwhile, the Vickers hardness test was conducted by using a micro Vickers hardness tester (manufactured by FUTURE-TECH CORP, Product name: FM-ARS900).

As a result, as indicated in Table of FIG. 3, it was possible to confirm that the press-fit terminals in Examples 1 and 2 have the sufficient hardness. On the other hand, it was confirmed that the hardness of the press-fit terminals in Comparative examples 1 and 2 is not sufficient.

It is considered that the factors resulting in the above-described result are the same as those in the case of the scraping suppression test.

### Crack Test

It was visually confirmed whether or not cracks occur on the plated surface layer of the press-fitting portion when the press-fitting portion was extracted from the through hole 21 after the press-fitting portion of each of the press-fit terminals in Examples 1 and 2, and Comparative examples 1 and 2 was press-fitted into the through hole 21 of the electronic circuit board 20. As a result, as indicated in Table of FIG. 3, the cracks were not found in any of press-fit terminals.

### Comprehensive Evaluation

From the above-described results, comprehensive evaluations of Examples 1 and 2 were determined as pass (O), and comprehensive evaluations of Comparative examples 1 and 2 were determined as failure (X).

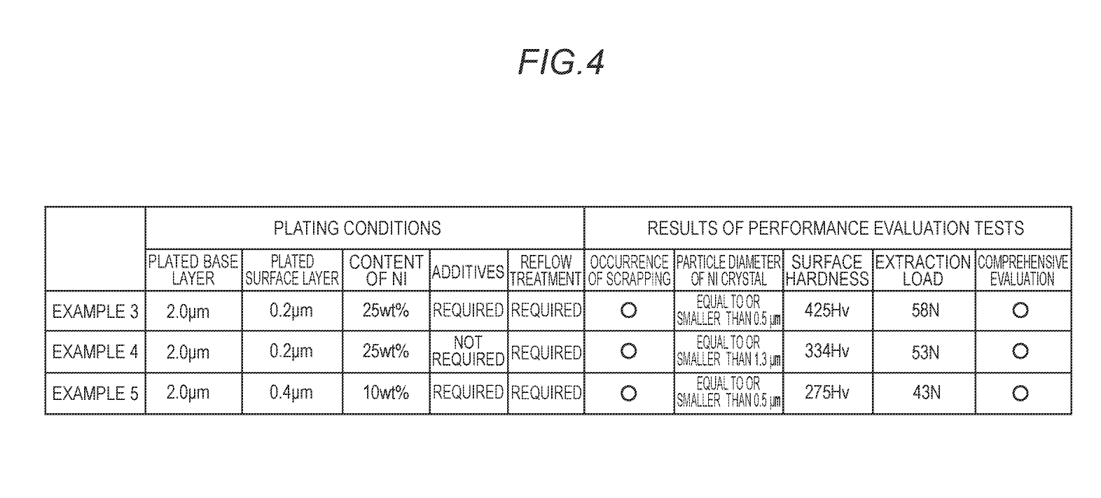

Subsequently, the second embodiment of this disclosure will be described mainly with reference to FIG. 4. Note that, the same members as those in the first embodiment are denoted by the same reference numerals, and the detailed description thereof will not be repeated.

A base structure of the press-fit terminal 10 of the embodiment is the same as that in the first embodiment. That is, the press-fit terminal 10 of the embodiment is also manufactured by performing the plating treatment on the surface of the base material which is obtained through the pressing process of the substrate. Further, the press-fit terminal 10 is provided with the base material 15, the plated base layer 16, and the plated surface layer 17.

The plated base layer 16 which is an Ni-coated film is formed on the surface (including the sectional view formed at the time of the pressing process) of the base material 15 which is made of Cu or a Cu alloy. The thickness of the plated base layer 16 is in a range of 1.5 to 2.0 μm.

The plated base layer 16 is formed on the surface of the base material 15 through the electroplating by using the plating solution containing Ni ions, for example. The plating solution includes saccharin as a primary brightening agent and 1,4-butynediol as a secondary brightening agent. Meanwhile, it is preferable that the surface treatment (such as electrolytic degreasing, acid washing, and water washing) is performed on the surface of the base material 15 before the plated base layer 16 is formed in the base material 15.

Further, the plated surface layer (coated film) 17 which is made of an Sn—Ni alloy and has a thickness of equal to or smaller than 0.3 μm is formed on the surface of the plated base layer 16.

The plated surface layer 17 is formed through the following steps, for example. That is, first, the Sn layer is formed on the surface of the plated base layer 16 through the electroplating by using the plating solution which contains the Sn ions. Next, the reflow treatment is performed on the press-fit terminal 10. Then, the plated base layer 16 and the plated surface layer 17 are melted. In addition, since the plated surface layer 17 is thin, Ni is diffused up to the outermost surface of the plated surface layer 17 (Ni is uniformly diffused in the inside of the plated surface layer) during the reflow treatment, and thus Ni appears on the outermost surface of the plated surface layer 17. In this way, the plated surface layer 17 is made of an Sn—Ni alloy.

Meanwhile, it is preferable that the surface treatment (such as acid washing, and water washing) is performed on the surface of the plated base layer 16 before the plating treatment is performed on the plated surface layer 17.

The plated base layer 16 is formed by using the plating solution which contains saccharin as a primary brightening agent and 1,4-butynediol as a secondary brightening agent. For this reason, the plated base layer 16 is formed in a state where the Ni crystal is fined. More specifically, the maximum particle diameter of the Ni crystal of the plated base layer 16 is equal to or smaller than 500 nm (nanometer). The Ni crystal in the plated base layer 16 is fined as described above, and thus the hardness of the plated base layer 16 becomes higher. Note that, the reason for that the hardness of the plated base layer 16 becomes higher is estimated as follows. That is, it is considered that when the Ni crystal in the plated base layer 16 is fined, the slipping between the Ni crystal particles in the plated base layer 16 (Ni-coated film) is suppressed, and thus the hardness of the coated film becomes higher. In addition, it is considered that saccharin and 1,4-butynediol contained in the plated base layer 16 are attached on the surface of the Ni crystal particle, the slipping between the Ni crystal particles is suppressed, and thus the hardness of the coated film becomes higher.

Further, the plated base layer 16 (Ni layer) which has the thickness larger than that of the plated surface layer 17 and the hardness higher than that of Sn is positioned in the inside of the plated surface layer 17. For this reason, the surface hardness of the press-fitting portion 11 becomes excessively high. Specifically, the surface hardness of the press-fitting portion 11 is equal to or greater than 400 Hv.

For this reason, when the press-fitting portion 11 of the press-fit terminal 10 is press-fitted into the through hole 21 of the electronic circuit board 20, it is less likely that the plated surface layer 17 which is the surface of the press-fitting portion 11 is scrapped by the surface of the through hole 21. Accordingly, it is possible to reliably connect the press-fit terminal 10 and the electronic circuit board 20 to each other.

Further, the thickness of the plated surface layer 17 (Sn layer) of the press-fit terminal 10 of the embodiment is equal to or smaller than 0.3 μm, and thus when the press-fitting portion 11 of the press-fit terminal 10 is extracted from the through hole 21, the plated surface layer 17 is less likely to be collapsed.

For this reason, an extraction load which is a load required to extract the press-fitting portion 11 of the press-fit terminal 10 from the through hole 21 becomes larger. In other words, it is less likely that the press-fit terminal 10 which is press-fitted into the through hole 21 is unexpectedly extracted from the through hole 21.

Meanwhile, in a case where the plated base layer 16 is formed by using the plating solution which does not contain the brightening agent (saccharin and 1,4-butynediol), the plated base layer 16 is formed in a state where the Ni crystal particles become larger. That is, the maximum particle diameter of the Ni crystal in the plated base layer 16 is larger than 500 nm. For this reasons, the hardness of the plated base layer 16 becomes lower. As a result, the surface hardness of the press-fitting portion 11 becomes lower. Thus, in this case, when the press-fitting portion 11 of the press-fit terminal 10 is extracted from the through hole 21, the surface of the plated surface layer 17 is easily collapsed. Therefore, in this case, the extraction load with respect to the through hole 21 of the press-fitting portion 11 becomes smaller.

In addition, in a case where the plated surface layer 17 (Sn layer) is set to be larger than 0.3 μm, when the press-fitting portion 11 is extracted from the through hole 21, the plated surface layer 17 (which is more flexible than the plated base layer 16) is easily collapsed. Accordingly, in this case, the extraction load with respect to the through hole 21 of the press-fitting portion 11 becomes smaller.

Subsequently, Example 3 of this disclosure will be described below. Note that, the same base material as that in Example 1 was used as a base material of the press-fit terminal in Example 3.

### Example 3

The press-fit terminal in Example 3 is manufactured by using the same manufacturing method as that of the press-fit terminal 10 in the second embodiment. As indicated in Table of FIG. 4, the thickness of the plated base layer 16 of the press-fit terminal in Example 3 is 2.0 μm, and the thickness of the plated surface layer 17 is 0.2 μm. In addition, the content of Ni in the plated surface layer 17 is 25 wt %. Further, the plating solution used at the time of forming the plated base layer 16 contains saccharin as a primary brightening agent and 1,4-butynediol as a secondary brightening agent.

The maximum particle diameter of the Ni crystal of the plated base layer 16 is equal to or smaller than 0.5 μm (500 nm). The particle diameter of the Ni crystal was measured in such a manner that a sectional image of the press-fit terminal was captured by using a field emission scanning electron microscope (FE-SEM manufactured by Hitachi, Ltd., Product name: SU-70), and the particle size (grain size) of the Ni crystal in the captured images is measured by using an electron beam backscatter diffraction analyzer (manufactured by Oxford Instruments, Product name: INCA X-act). Note that, the maximum particle diameter of the Ni crystal in Examples 4 and 5 which will be described below are also measured by using the same apparatus and the same method as described above.

Subsequently, the results of the performance evaluation test in Example 3 will be described.

### Scraping Suppression Test

The amount of the scrapings generated in the plating was visually confirmed after the press-fitting portion of the press-fit terminal in Example 3 was press-fitted (inserted) into the through hole 21 of the electronic circuit board 20. Specifically, after the press-fit terminal is inserted into the through hole 21, the existence of the scrapings generated in the plating which are collected in the vicinity of the through hole 21 was visually evaluated with the press-fit terminals in a state of being inserted into the through hole 21. As a result, the scrapings were not confirmed in Example 3 as indicated in Table of FIG. 4.

As will be described below, the surface hardness of the press-fitting portion of the press-fit terminal in Example 3 is excessively high. For this reason, it is estimated that the plated surface layer of the press-fitting portion in Example 3 was almost not scrapped.

### Surface Hardness Test

The surface hardness of the press-fit terminal in Example 3 is measured through the Vickers hardness test. Note that, the Vickers hardness test was conducted by using a micro Vickers hardness tester (manufactured by FUTURE-TECH CORP, Product name: FM-ARS900).

As a result, as indicated in Table of FIG. 4, it was possible to confirm that the press-fit terminal in Example 3 has excessively high surface hardness (the surface hardness which is equal to or higher than 400 Hv).

### Extraction Load Test

A load measuring device was connected to the press-fit terminal in Example 3, the press-fitting portion was press-fitted into the through hole 21 of the electronic circuit board 20, and then the load measuring device was pull out so as to extract the press-fitting portion from the through hole 21. In addition, when the press-fitting portion was extracted from the through hole 21, the load was measured by using an automatic load tester (manufactured by JAPAN INSTRUMENTATION SYSTEM Co., Ltd, Product name: MAX series desktop type).

As a result, the extraction load in Example 3 was sufficiently large as indicated in Table of FIG. 4.

### Comprehensive Evaluation

From the results described above, the comprehensive evaluation of Example 3 was determined as pass (O).

Subsequently, the third embodiment of this disclosure will be described mainly with reference to FIG. 4. Note that, the same members as those in the first and second embodiments are denoted by the same reference numerals, and the detailed description thereof will not be repeated.

A base structure of the press-fit terminal 10 of the embodiment is the same as those in the first and second embodiments.

The plated base layer 16 which is an Ni-coated film is formed on the surface (including the sectional view formed at the time of the pressing process) of the base material 15. The thickness of the plated base layer 16 is in a range of 1.5 to 2.0 μm.

The plated base layer 16 is formed on the surface of the base material 15 through the electroplating by using the plating solution containing Ni ions, for example. Here, the plating solution does not include saccharin as a primary brightening agent and 1,4-butynediol as a secondary brightening agent. Meanwhile, it is preferable that the surface treatment (such as electrolytic degreasing and water washing) is performed on the surface of the base material 15 before the plated base layer 16 is formed in the base material 15.

Further, the plated surface layer (coated film) 17 which is made of an Sn—Ni alloy and has a thickness of equal to or smaller than 0.3 μm is formed on the surface of the plated base layer 16.

The plated surface layer 17 is formed through the same steps as those in the second embodiment, for example.

Further, the plated base layer 16 (Ni layer) which has the thickness larger than that of the plated surface layer 17 and the hardness higher than that of Sn is positioned in the inside of the plated surface layer 17. For this reason, the surface hardness of the press-fitting portion 11 becomes high. Specifically, the surface hardness of the press-fitting portion 11 is equal to or greater than 330 Hv.

For this reason, when the press-fitting portion 11 of the press-fit terminal 10 is press-fitted into the through hole 21 of the electronic circuit board 20, it is less likely that the plated surface layer 17 which is the surface of the press-fitting portion 11 is scrapped by the surface of the through hole 21. Accordingly, it is possible to reliably connect the press-fit terminal 10 and the electronic circuit board 20 to each other.

Moreover, the thickness of the plated surface layer 17 (Sn layer) of the press-fit terminal 10 of the embodiment is equal to or smaller than 0.3 μm, and thus when the press-fitting portion 11 of the press-fit terminal 10 is extracted from the through hole 21, the plated surface layer 17 is less likely to be collapsed.

For this reason, an extraction load which is a load required to extract the press-fitting portion 11 of the press-fit terminal 10 from the through hole 21 becomes larger. In other words, it is less likely that the press-fit terminal 10 which is press-fitted into the through hole 21 is unexpectedly extracted from the through hole 21.

Subsequently, Example 4 of this disclosure, which is an example of the third embodiment, will be described below. Note that, the same base material as that in Example 1 was used as a base material of the press-fit terminal in Example 4.

### Example 4

The press-fit terminal in Example 4 is manufactured by using a different manufacturing method from that of the press-fit terminal 10 in the second embodiment. As indicated in Table of FIG. 4, the thickness of the plated base layer of the press-fit terminal in Example 4 is 2.0 μm, and the thickness of the plated surface layer is 0.2 μm. In addition, the content of Ni in the plated surface layer is 25 wt %. Here, the plating solution used at the time of forming the plated base layer does not contain saccharin as a primary brightening agent and 1,4-butynediol as a secondary brightening agent.

Subsequently, the results of the performance evaluation test in Example 4 will be described.

### Scraping Suppression Test

The scrapings generated in the plating in the press-fit terminal in Example 4 was visually confirmed in the same way as that used in Example 3. As a result, the scrapings were not confirmed in Example 4 as indicated in Table of FIG. 4.

As will be described below, the surface hardness of the press-fitting portion of the press-fit terminal in Example 4 is correspondingly high. For this reason, it is estimated that the plated surface layer of the press-fitting portion in Example 4 was almost not scrapped.

### Surface Hardness Test

The surface hardness of the press-fit terminal in Example 4 is measured through the Vickers hardness test in the same way used in Example 3.

As a result, as indicated in Table of FIG. 4, it was possible to confirm that the press-fit terminal in Example 4 has correspondingly high surface hardness (the surface hardness which is equal to or higher than 330 Hv). That is, it was possible to confirm that the press-fit terminal in Example 4 has the surface hardness which is equal to or more than twice as high as that in Comparative examples 1 and 2.

### Extraction Load Test

When the press-fitting portion of the press-fit terminal in the Example 4 was extracted from the through hole 21, the load was measured in the same way as that used in Example 3.

As a result, it was confirmed that the extraction load in Example 4 was correspondingly high large as indicated in Table of FIG. 4.

### Comprehensive Evaluation

From the results described above, the comprehensive evaluation of Example 4 was determined as pass (O).

Subsequently, the fourth embodiment of this disclosure will be described mainly with reference to FIG. 4. Note that, the same members as those in the first to third embodiments are denoted by the same reference numerals, and the detailed description thereof will not be repeated.

A base structure of the press-fit terminal 10 of the embodiment is the same as those in the first to third embodiments.

The plated base layer 16 which is an Ni-coated film is formed on the surface (including the sectional view formed at the time of the pressing process) of the base material 15. The thickness of the plated base layer 16 is in a range of 1.5 to 2.0 μm.

The plated base layer 16 is formed through the same steps as those in the second embodiment, for example. That is, the plated base layer 16 is formed on the surface of the base material 15 through the electroplating by using the plating solution containing Ni ions, for example. The plating solution contains saccharin as the primary brightening agent and 1,4-butynediol as the secondary brightening agent.

Further, the plated surface layer (coated film) 17 which is made of an Sn—Ni alloy and has a thickness of equal to or smaller than 0.3 μm is formed on the surface of the plated base layer 16.

The plated surface layer 17 is formed through the same steps as those in the second and third embodiments, for example.

Further, the plated base layer 16 (Ni layer) which has the thickness larger than that of the plated surface layer 17 and the hardness higher than that of Sn is positioned in the inside of the plated surface layer 17. For this reason, the surface hardness of the press-fitting portion 11 becomes high. Specifically, the surface hardness of the press-fitting portion 11 is equal to or greater than 270 Hv.

For this reason, when the press-fitting portion 11 of the press-fit terminal 10 is press-fitted into the through hole 21 of the electronic circuit board 20, it is less likely that the plated surface layer 17 which is the surface of the press-fitting portion 11 is scrapped by the surface of the through hole 21. Accordingly, it is possible to reliably connect the press-fit terminal 10 and the electronic circuit board 20 to each other.

Moreover, the thickness of the plated surface layer 17 (Sn layer) of the press-fit terminal 10 of the embodiment is equal to or smaller than 0.4 μm, and thus when the press-fitting portion 11 of the press-fit terminal 10 is extracted from the through hole 21, the plated surface layer 17 is less likely to be collapsed.

For this reason, an extraction load which is a load required to extract the press-fitting portion 11 of the press-fit terminal 10 from the through hole 21 becomes larger. In other words, it is less likely that the press-fit terminal 10 which is press-fitted into the through hole 21 is unexpectedly extracted from the through hole 21.

Subsequently, Example 5 of this disclosure, which is an example of the fourth embodiment, will be described below. Note that, the same base material as that in Example 1 was used as a base material of the press-fit terminal in Example 5.

### Example 5

The press-fit terminal in Example 5 is manufactured by using the same manufacturing method as that of the press-fit terminal 10 in the second embodiment. As indicated in Table of FIG. 4, the thickness of the plated surface layer of the press-fit terminal in Example 5 is 0.4 μm. In addition, the content of Ni in the plated surface layer is 10 wt %.

Subsequently, the results of the performance evaluation test in Example 5 will be described.

### Scraping Suppression Test

The scrapings generated in the plating in the press-fit terminal in Example 5 was visually confirmed in the same way as that used in Example 3. As a result, the scrapings were not confirmed in Example 5 as indicated in Table of FIG. 4.

As will be described below, the surface hardness of the press-fitting portion of the press-fit terminal in Example 5 is correspondingly high. For this reason, it is estimated that the press-fitting portion of the press-fit terminal in Example 5 was almost not scrapped.

### Surface Hardness Test

The surface hardness of the press-fit terminal in Example 5 is measured through the Vickers hardness test in the same way used in Example 3.

As a result, as indicated in Table of FIG. 4, it was possible to confirm that the press-fit terminal in Example 5 has correspondingly high surface hardness (the surface hardness which is equal to or higher than 270 Hv). That is, it was possible to confirm that the press-fit terminal in Example 5 has the surface hardness which is equal to or more than twice as high as that in Comparative examples 1 and 2.

### Extraction Load Test

When the press-fitting portion of the press-fit terminal in the Example 5 was extracted from the through hole 21, the load was measured in the same way as that used in Example 3.

As a result, it was confirmed that the extraction load in Example 5 was correspondingly high large as indicated in Table of FIG. 4.

### Comprehensive Evaluation

From the results described above, the comprehensive evaluation of Example 5 was determined as pass (O).

As described above, the respective embodiments of this disclosure are described; however, this disclosure is not limited to the above-described embodiment.

For example, the main component of the base material of the press-fit terminal 10 may be made of metal other than Cu.

The press-fit terminal 10 of the first embodiment may not be provided with the plated base layer 16.

It is preferable that a press-fit terminal according to an aspect of this disclosure includes a base material and a plated surface layer which is obtained by plating a surface of the base material with an Sn—Ni alloy.

In the aspect of this disclosure, the plated surface layer made of the Sn—Ni alloy is formed on the surface of the press-fit terminal.

Ni is uniformly dispersed in the plated surface layer, and appears on the outer most surface of the plated surface layer. For this reason, it is possible to set the surface hardness of the entire plated surface layer to be sufficiently high.

Accordingly, it is possible to prevent the surface of the press-fit terminal from being scrapped when the press-fit terminal is press-fitted into the through hole on the electronic circuit board.

The content of Ni in the plated surface layer may be in a range of 10 wt % to 40 wt %.

In a case where the content of Ni in the plated surface layer is less than 10 wt %, the degree of the surface hardness of the entire plated surface layer is not sufficient. Therefore, in this case, it is likely that the surface of the press-fit terminal is scrapped when the press-fit terminal is press-fitted into the through hole on the electronic circuit board.

Also, in a case where the content of Ni in the plated surface layer is more than 40 wt %, the contact resistance with respect to the through hole of the electronic circuit board of the press-fit terminal becomes excessively larger.

However, when the content of Ni in the plated surface layer is set to be in the range of 10 wt % to 40 wt %, it is possible to reduce the occurrence of the above-described defects.

The base material may be made of Cu or a Cu alloy, the press-fit terminal may further include a plated base layer which is an Ni-coated film between the base material and the plated surface layer, the thickness of the plated surface layer may be equal to or smaller than 0.3 μm, and the maximum particle diameter of Ni crystal in the plated base layer may be equal to or smaller than 500 nanometers.

Note that, the meaning of a term “Ni-coated film” in this specification not only includes “a coated film containing only Ni” but also includes “a coated film containing Ni and other components in addition to Ni”.

With such a configuration, it is possible to prevent Cu in the base material from being diffused in the plated surface layer (Sn) by the plated base layer which is the Ni-coated film. In addition, as the hardness of the plated base layer is high and the plated surface layer is thinned, the surface hardness of the press-fit terminal is high.

The plated base layer may contain saccharin and 1,4-butynediol as brightening agents.

With such a configuration, the plated base layer is formed in a state where the Ni crystal is fined. Accordingly, it is possible to set the maximum particle diameter of the Ni crystal in the plated base layer to be equal to or smaller than 500 nm (nanometer).

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A press-fit terminal comprising:
a base material; and
a plated surface layer which is obtained by plating a surface of the base material with an Sn—Ni alloy.

2. The press-fit terminal according to claim 1,
wherein the content of Ni in the plated surface layer is in a range of 10 wt % to 40 wt %.

3. The press-fit terminal according to claim 1,
wherein the base material is made of Cu or a Cu alloy,
wherein the press-fit terminal further comprises a plated base layer which is an Ni-coated film between the base material and the plated surface layer,
wherein the thickness of the plated surface layer is equal to or smaller than 0.3 μm, and
wherein the maximum particle diameter of Ni crystal in the plated base layer is equal to or smaller than 500 nanometers.

4. The press-fit terminal according to claim 3,
wherein the plated base layer contains saccharin and 1,4-butynediol as brightening agents.
